(19) United States
(12) Patent Application Publication
(10) Pub. No.: US 2011/0153642 A1
(43) Pub. Date: Jun. 23, 2011

(54) Client Relationship Management

(75) Inventors: Patrick Joseph O'Sullivan, Ballsbridge Dublin (IE); Edith Helen Stern, Yorktown Heights, NY (US); Barry E. Willner, Briarcliff Manor, NY (US)

(73) Assignee: INTERNATIONAL BUSINESS MACHINES CORPORATION, Armonk, NY (US)

(21) Appl. No.: 12/643,768

(22) Filed: Dec. 21, 2009

(51) Int. Cl. G06N 5/02; G06F 17/30

(52) U.S. Cl. 707/769; 706/50; 707/783; 707/E17.005; 707/E17.017

(57) ABSTRACT

Managing a relationship between an organization and clients of the organization based on data stored on a server by the organization includes determining that data stored on the server represents a prospective interaction between a member of the organization and a client of the organization, searching the server for additional data related to the client of the organization, and providing a suggestion for optimizing the interaction to at least the member, the suggestion being based on a logical deduction made from the data representing the interaction and the additional data returned as a result of the searching.

### BACKGROUND

Aspects of the present invention relate in general to managing interactions between an organization and clients of the organization, and more particularly, to automated client relationship management (CRM) solutions.

Many organizations employ Customer Relationship Management (CRM) systems to help manage the relationships between their members and their clients. As clients may interact with different members of an organization that have diverse roles and are assigned to different departments within the organization, it may be difficult to obtain an accurate general view of the various interactions that occur between any one client and the organization. Consequently, it may be difficult for an organization to coordinate these interactions in a way that addresses the specific needs of the client.

Many CRM systems require members of an organization to document every interaction with a client or customer. The information provided by the members of the organization may then be compiled to make reports for an individual member of the organization based on a particular client's exposure to that member of the organization. However, these reports may often lack important data due to organization members forgetting to enter data, being unaware of a responsibility to enter data, or simply lacking the knowledge necessary to properly enter the appropriate data into the CRM system.

### BRIEF SUMMARY

A method for managing a relationship between an organization and clients of the organization based on data stored on a server by the organization includes determining that data stored on the server represents a prospective interaction between a member of the organization and a client of the organization, searching the server for additional data related to the client of the organization, and providing a suggestion for optimizing the interaction to at least the member, the suggestion being based on a logical deduction made from the data representing the interaction and the additional data returned as a result of the searching.

A system for managing a relationship between an organization and clients of the organization based on data stored on a server by the organization includes a server. The server includes a processor and a memory communicatively coupled to the processor, the memory comprising executable code stored thereon such that the executable code, when executed by the processor, causes the processor to determine that data stored on the memory represents a prospective interaction between a member of the organization and a client of the organization, search the memory for additional data related to the client of the organization, and provide a suggestion for optimizing the interaction to at least the member, the suggestion being based on a logical deduction made from the data representing the interaction and the additional data returned as a result of the searching.

A computer program product for managing a relationship between an organization and clients of the organization based on data stored on a server by the organization includes computer readable program code configured to determine that data stored on the server represents a prospective interaction between a member of the organization and a client of the organization, computer readable program code configured to search the server for additional data related to the client of the organization, and computer readable program code configured to provide a suggestion for optimizing the interaction to at least the member, the suggestion being based on a logical deduction made from the data representing the interaction and the additional data returned as a result of the searching.

### BRIEF DESCRIPTION OF THE SEVERAL VIEWS OF THE DRAWINGS

The accompanying drawings illustrate various embodiments of the principles described herein and are a part of the specification. The illustrated embodiments are merely examples and do not limit the scope of the claims.

FIG. 1 is a diagram showing an illustrative server, according to one embodiment of principles described herein.

FIG. 2 is a diagram showing an illustrative depiction of the server operation, according to one embodiment of principles described herein.

FIGS. 3A and 3B are diagrams showing illustrative computer application interfaces, according to one embodiment of principles described herein.

FIG. 4 is a diagram showing an illustrative table representing information stored within a database, according to one embodiment of principles described herein.

FIG. 5 is a flowchart showing an illustrative method for managing and improving interactions between members of an organization and their clients, according to one embodiment of principles described herein.

Throughout the drawings, identical reference numbers designate similar, but not necessarily identical, elements.

### DETAILED DESCRIPTION

The present specification relates to methods and systems for managing and improving relations between members of an organization and their clients. According to certain illustrative embodiments, a server may be configured to store data related to interactions between a member of an organization and a client of that organization. The data stored on the server may be collected by searching the computer applications of members of the organization for information relating to interactions between the members and clients. These computer applications may be installed on various workstations which may be communicatively couples to the server. These computer applications may include, but are not limited to, calendar applications, scheduling applications, email applications, and other communication applications. The server may be further configured to provide at least one suggestion on how to optimize a particular prospective interaction with a particular client based on previous interactions between the organization and the client and/or other data stored about the client by the server. The suggestion may be provided in response to a member of the organization scheduling the prospective interaction with the client through a computer application. The suggestions may be derived using rule-based systems.

A computing system embodying principles described herein may not require a user to separately enter data into a CRM system relating to every interaction between that user and a client. Instead, data from software applications used by the member, such as his or her electronic planner or calendar application, may be exposed to a CRM application to provide the CRM application with relevant client interaction data

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

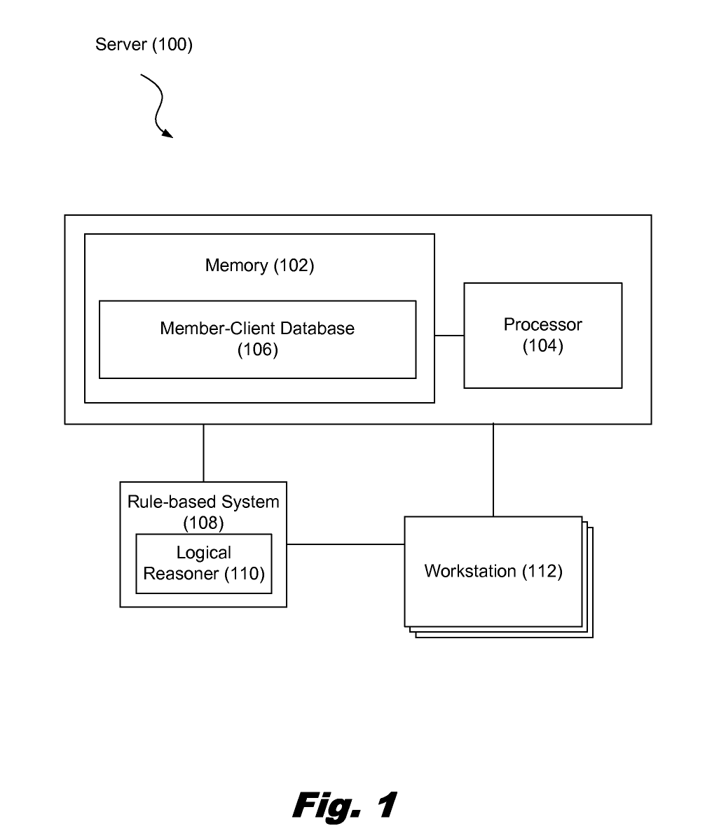

Referring now to the figures, FIG. 1 is a diagram showing an illustrative server (100). According to certain embodiments, a server (100) may include a processor (104) and a memory (102) having a member-client database (106) stored thereon. The server (100) may be communicatively coupled to a rule-based system and several workstations (112).

A typical physical computing system such as a server generally includes a form of memory (102). There are many types of memory available. Some types of memory, such as hard disk drives, optical disc drives, and solid state drives, are designed for storage. These types of memory typically have large storage volume but relatively slow performance. Other types of memory, such as those used for Random Access Memory (RAM), are optimized for speed and are often referred to as “working memory.” The various forms of memory may store information in the form of data and software.

The data acquired by the server (100) may be placed in a member-client database (106). Doing so will allow a member of the organization to query the database in order to find relevant information about member-client relationships.

A rule-based system (108) provides a means to store and interpret data. A rule-based system may be configured to work with a set of rules. The rules may include a number of axioms and conditional statements. The rule-based system may employ a logical reasoner (110) to make logical inferences from a given set of axioms according to a defined set of rules. In certain embodiments, the rule-based system (108) may be implemented by the server (100) itself. Alternatively, the rule-based system (108) may be implemented by a separate physical computing device communicatively coupled to the server (100).

A logical reasoner (110) is a software entity often configured to use first-order logic. In certain embodiments, a rule-based system (108) may employ a logical reasoner (110) which uses description logic. Description logic is a knowledge based language which is used to describe logical statements in a clear and consistent manner.

A server may acquire data by searching through computer applications associated with various workstations (112). A workstation may be any physical computing device capable of being communicatively coupled to the server (100). A workstation may include, but is not limited to, a desktop computer, a laptop computer, a smart phone, or a personal digital assistant device.

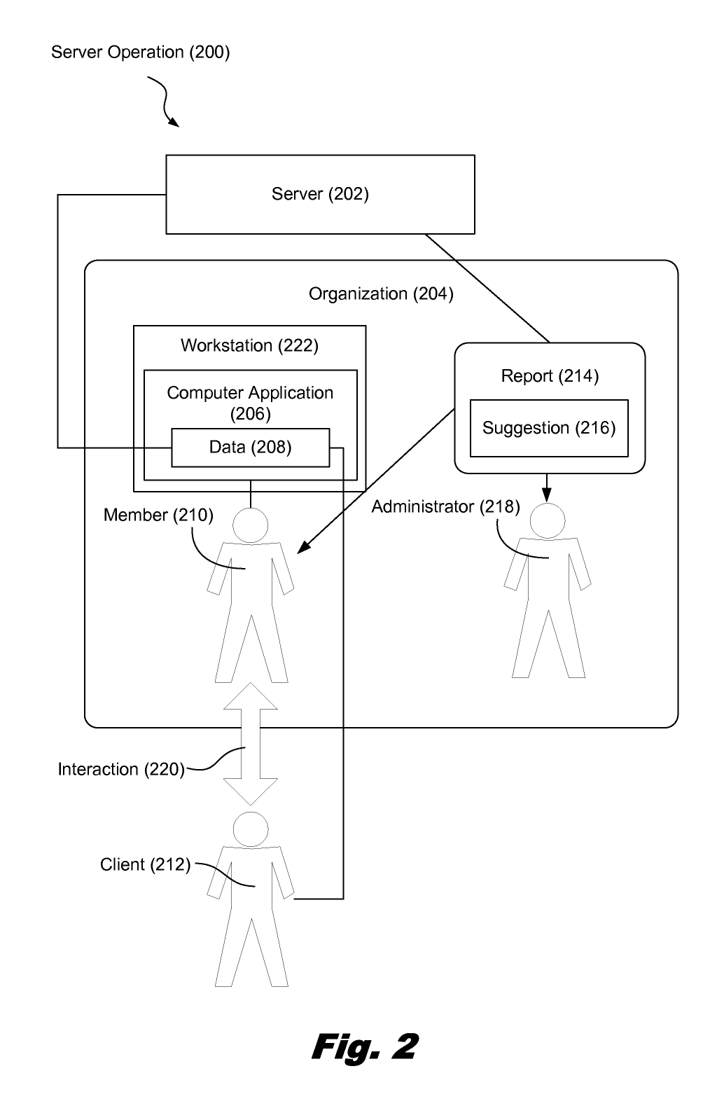

FIG. 2 is a diagram showing an illustrative depiction of the server operation (200). According to certain embodiments, a server (202) may be configured to search data (208) within a computer application (206) associated with a member (210) of an organization (204). The server (202) may be configured to look for data (208) relating to an interaction (220) between the member (210) and a client (212). The server (202) may be configured to provide a report (214) including a suggestion (216) to an administrator (218), the report being based off of data acquired by the server (202).

Many members (210) of an organization (204) such as employees of a business may use a variety of computer applications (206) to manage their busy schedules. These computer applications (206) may include, but are not limited to, email and other communication applications, calendar and other scheduling applications, spreadsheet applications, database applications, workflow planning applications, docketing applications, and the like. Through these computer applications (206), a user may enter data (208) of a variety of types including, but not limited to, scheduled meetings or phone calls with a client (212), client information, and the client's organization information. The data (208) may also include recorded communications from email, instant messaging, and other communication applications. Computer applications (206) may be executed locally on a workstation (222), remotely by a server (202) in a way that is accessible to a user of a workstation (222), or some combination thereof

Many organizations (204) make use of a company intranet. An intranet is a locally operated network which connects the various workstations used by the members (210) of an organization (204) together. An intranet is often available exclusively to members (210) of a given organization (204). However, in some cases, clients (212) of the organization may be given access to certain aspects of an organization's intranet. As mentioned above, a server (202) may be configured to search the computer applications (206) of each member (210) using a workstation on an organization's intranet.

Members (210) of an organization (204) interact with their clients (212) through a variety of methods. These types of interactions may include, but are not limited to, personal appointments, emails, phone calls, teleconferences, and web-conferences. These types of interactions (220) are typically documented in some form in a computer application. For example, if a member interacts (220) with a client through email, the emailing application will maintain a record of those emails. In a further example, if a member (210) schedules a lunch appointment with a client (212), that appointment may be placed in the member's calendar application. The data from the meeting may then be available to the server (202).

The server (100) may be configured to compile a report (214) based on the data (208) acquired from the computer applications (206) associated with various members (210) of an organization (204). The report (214) may be created periodically and be given to certain members of the organization such as administrators. In some embodiments, reports (214) related to interactions (220) between certain members (210) and their clients (212) may be given to those members (210) directly. The report (214) may be presented in such a way as to give an overview of the interaction (220) and relationships between given members (210) of an organization (204) and given clients (212) of the organization (204). The report (214) may also include data (208) that was entered into a system manually.

A report (214) may also provide a reader with suggestions (216) for improving relations and optimizing interactions (220) between members (210) of the organization (204) and their clients (212). These suggestions (216) may be given to administrators (218) within the organization (204) or directly to members (210) for whom the suggestions (216) apply. The suggestion (216) may be derived from the data (208) acquired by the server (202) and a logical deduction made by the server (202). In one embodiment, software stored on the server (202) may be configured as a rule based system and logical reasoner. The data (208) acquired by the server (202) from the computer applications (206) may be placed in a form to be used by the rule-based system associated with the server (202).

In one example, it may be a policy of an organization (204) for an office manager to notify a client (212) through email that the organization (204) is beginning work on a project for the client (212). A member (210) of the organization (204) working on the project may also need to interact with the client (212) to start work on the project. If the member (210) schedules an appointment to meet with an assigned client (212) and the system finds evidence of that scheduled interaction (220) as well as evidence that the office manager has not yet notified the client (212), a suggestion (216) included in a report (214) may be for the office manager to go ahead and send out the notification email. In certain embodiments, a rule based-system may be configured to store various company policies which have been translated into rules and axioms capable of being processed by the logical reasoner. When compiling a report (214), the suggestion (216) may be created as a result of a logical deduction processed by the logical reasoner. Those familiar in the art of rule-based systems may appreciate various methods of implantation regarding the formation of such suggestions (216).

In a further example, the system may determine from the data (208) stored on the server (202) that two sales teams have scheduled interactions (220) with the same potential client. A report (214) may be formed which includes a suggestion (216) to reassign one of the teams to a new potential client, thus making the organization (204) more efficient.

In another example, the system may detect a pattern in the data stored on the server relating to a clients behavior. The system may then provide a suggestion to reschedule the interaction (220) to a time and date when it is more likely that the client (212) will be available. Additionally, the pattern may indicate that a client never responds to email. Thus, a suggestion may be to try to contact the client by phone.

In some cases, the report (214) may be created periodically and provided to an administrator (218) within the organization (204). Additionally or alternatively, the report may be formed at any time as requested by the administrator (218).

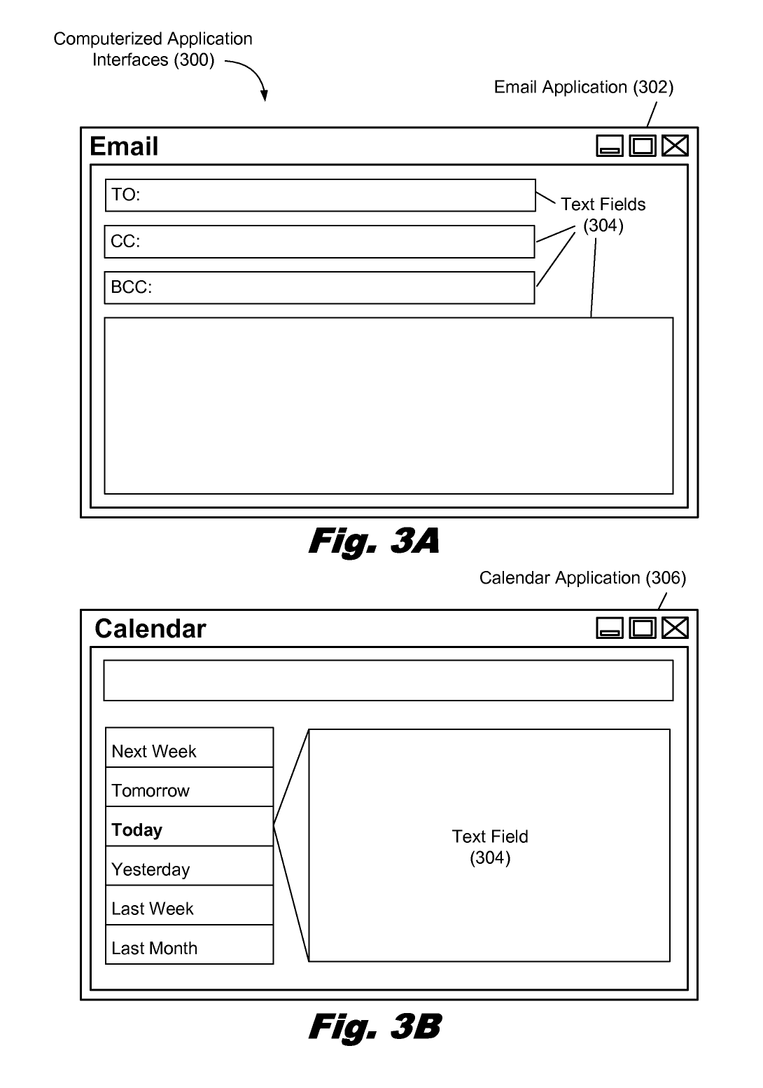

FIGS. 3A and 3B are diagrams showing illustrative computer application interfaces (300). According to certain embodiments, a server may be configured to search for data within text fields (304) associated with a computerized email application (302) or a computerized calendar application (306).

FIG. 3A is an example of an email application (302). An email application typically includes several text fields (304). The text fields (304) may include a “to” field, a “cc” field, a “bcc” field in which a user determines who will receive an email message. A text field is also provided for a user to write the email message. According to certain embodiments, the server may search for data within these and other types of text fields for information entered by a member of an organization relating to interactions between the member and a client. In some embodiments, fuzzy matching may be used to correlate data with various clients.

FIG. 3B is an example of a calendar application (306). Calendar applications typically have text fields associated with dates and times. The text fields often allow a user to enter information related to appointments and other scheduled events. According to certain embodiments, the server may search for data within these and other types of text fields for information entered by a member of an organization relating to interactions between the member and a client.

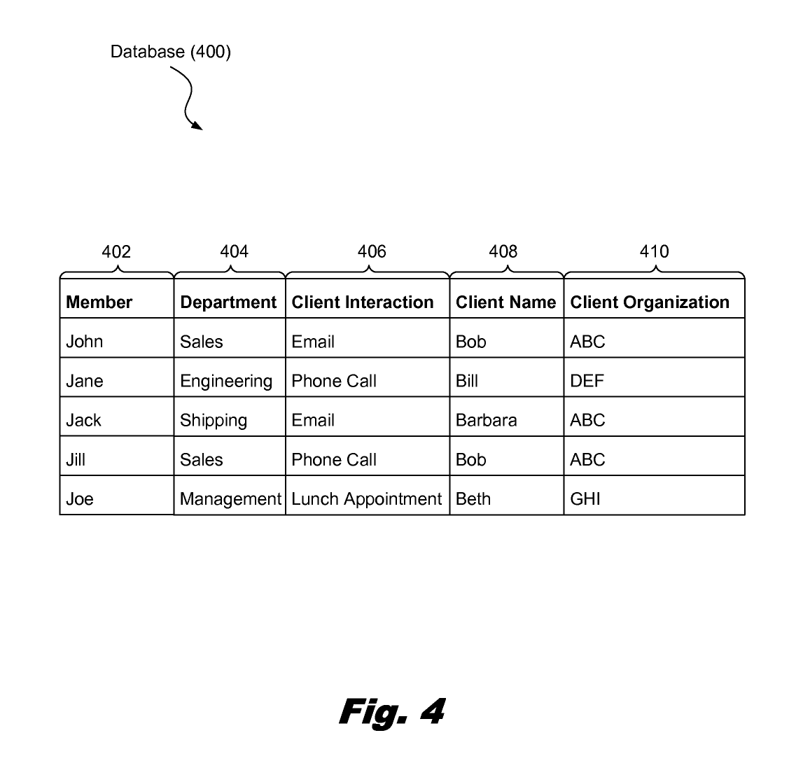

FIG. 4 is a diagram showing an illustrative table representing information stored within a database (400). According to certain illustrative embodiments, each row within the database may represent a particular interaction. The interaction may be associated with a member or group within the organization indicated by the “Member” column (402). The “Department” column may indicate which department within the organization that the member who interacted with the client is in. The type of interaction with the client may be denoted by the “Client Interaction” column. The client name or group may be indicated by the client name column (408). Additionally the organization associated with a client may also be available in the “Client organization” column (410).

A member of the organization may have the ability to query the database in order to find information related to specific types of interactions between members and clients. For example, an administrator within the organization may wish to view a report which includes all the interactions with a particular client. The system may be configured to query the database stored on the server to provide the appropriate report as requested by the administrator.

When a member of an organization uses a computer application to schedule an appointment with a particular client, the system may be configured to query the database to find a number of past interactions between the organization and the client. The system may also search other computer applications associated with members of the network to find additional data related to the particular client. The data retrieved from querying the database (400) may then be placed in the form of rules which are able to be processed by a rule-based system. An example of a rule would be to equate a member of the organization with a scheduled interaction. When several rules are processed by a logical reasoner, it may determine that there is a conflict in the rules. For example if two members are scheduled to meet with the same client at the same time. The system may then provide an automated response to detecting such a conflict. The automated response may be in the form of a suggestion for one of the members to reschedule his or her interaction with the client.

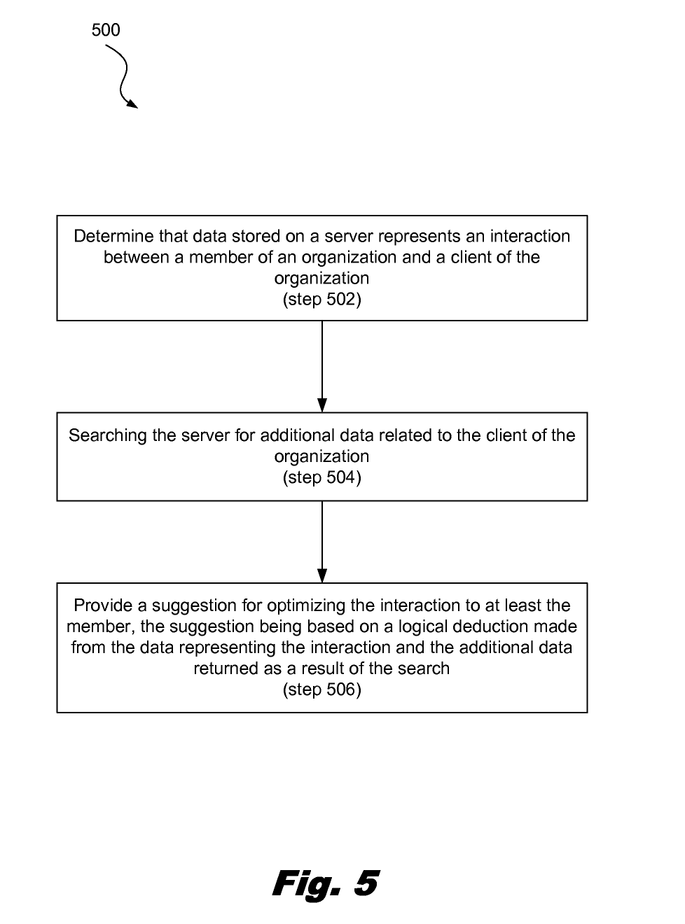

FIG. 5 is a flowchart showing an illustrative method for managing and improving interactions between members of an organization and their clients. According to certain illustrative embodiments, a method for managing a relationship between an organization and clients of the organization based on data stored on a server by the organization includes determining (step 502) that data stored on the server represents an interaction between a member of the organization and a client of the organization, searching (step 504) the server for additional data related to the client of the organization, and providing (step 506) a suggestion for optimizing the interaction to at least the member, the suggestion being based on a logical deduction made from the data representing the interaction and the additional data returned as a result of the searching.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method for managing a relationship between an organization and clients of said organization based on data stored on a server by said organization, the method comprising:
determining that data stored on said server represents a prospective interaction between a member of said organization and a client of said organization;
searching said server for additional data related to said client of said organization; and
providing a suggestion for optimizing said interaction to at least said member, said suggestion being based on a logical deduction made from said data representing said interaction and said additional data returned as a result of said searching.

2. The method of claim 1, in which said data stored on said server that represents said prospective interaction comprises data entered by a user of a computer application through a workstation communicatively coupled to said server.

3. The method of claim 2, in which said computer application comprises at least one of an email application and a scheduling application.

4. The method of claim 3, in which said searching said server is performed in response to said user creating a scheduled event in said scheduling application, said scheduled event representing said prospective interaction between said member of said organization and said client of said organization.

5. The method of claim 2, in which said member of said organization and said user of said computer application are the same person.

6. The method of claim 2, in which said searching said server is performed in response to a request from an administrator.

7. The method of claim 2, in which said determining if said data stored on said server represents a prospective interaction between said member and said client further comprises detecting an identifier within a text field associated with said computer application, said identifier being associated with said client.

8. The method of claim 2, in which said searching said data on said server is limited by a set of restrictions as to which data may be searched.

9. The method of claim 2, in which said data on said server further comprises data manually entered to a database of said server, said data being related to said client of said organization.

10. The method of claim 1, further comprising generating a report based on said data representing said prospective interaction and said additional data returned as a result of said searching.

11. The method of claim 1, in which said suggestion comprises a suggestion to assign said prospective interaction to a different member of said organization.

12. The method of claim 1, in which said suggestion comprises a suggestion that said member of said organization collaborate with an alternate member of said organization that is also interacting with said client.

13. The method of claim 1, in which said suggestion comprises a suggestion to reschedule said prospective interaction.

14. The method of claim 1, in which said suggestion comprises a suggestion to use an alternate means of communication for said prospective interaction

15. A system for managing a relationship between an organization and clients of said organization based on data stored on a server by said organization, said system comprising:
a server comprising:
a processor;
a memory communicatively coupled to said processor, said memory comprising executable code stored thereon such that said executable code, when executed by said processor, causes said processor to:
determine that data stored on said memory represents a prospective interaction between a member of said organization and a client of said organization;
search said memory for additional data related to said client of said organization; and
provide a suggestion for optimizing said interaction to at least said member, said suggestion being based on a logical deduction made from said data representing said interaction and said additional data returned as a result of said searching.

16. The system of claim 15, in which said data stored on said server that represents said prospective interaction comprises data entered by a user of a computer application through a workstation communicatively coupled to said server.

17. The system of claim 16, in which said computer application comprises at least one of an email application and a scheduling application.

18. The system of claim 17, in which said searching said server is performed in response to said user creating a scheduled event in said scheduling application, said scheduled event representing said prospective interaction between said member of said organization and said client of said organization.

19. The system of claim 15, in which said suggestion comprises a suggestion to assign said prospective interaction to a different member of said organization.

20. A computer program product for managing a relationship between an organization and clients of said organization based on data stored on a server by said organization, said computer program product comprising:
a computer readable storage medium having computer readable program code embodied therewith, the computer readable program code comprising:
computer readable program code configured to determine that data stored on said server represents a prospective interaction between a member of said organization and a client of said organization;
computer readable program code configured to search said server for additional data related to said client of said organization; and
computer readable program code configured to provide a suggestion for optimizing said interaction to at least said member, said suggestion being based on a logical deduction made from said data representing said interaction and said additional data returned as a result of said searching.
